(19) United States
(12) Patent Application Publication
(10) Pub. No.: US 2008/0001077 A1
(43) Pub. Date: Jan. 3, 2008

(54) Charged particle beam drawing apparatus, charged particle beam drawing method and semiconductor device manufacturing method

(76) Inventors: Tetsuro Nakasugi, Yokohama-shi (JP); Takeshi Koshiba, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/808,070

(22) Filed: Jun. 6, 2007

(30) Foreign Application Priority Data
Jun. 7, 2006 (JP) 2006-158795

(51) Int. Cl. G01D 18/00; G03C 5/00

(52) U.S. Cl. 250/252.1; 430/30

(57) ABSTRACT

A charged particle beam drawing apparatus is disclosed, which includes a drawing section which draws a pattern on a resist film applied to a substrate to be processed on which a under-layer mark is formed, by a charged particle beam, a position computing section which computes a position of the under-layer mark and a position of a displacement measuring pattern drawn by the drawing section on the resist film using a correction coefficient, by scanning the under-layer mark and the displacement measuring pattern by a charged particle beam, a displacement amount computing section which computes an amount of displacement from the positions of the under-layer mark and the displacement measuring pattern, and a correcting section which corrects the correction coefficient according to the amount of displacement.

### CROSS-REFERENCE TO RELATED APPLICATIONS

This application is based upon and claims the benefit of priority from prior Japanese Patent Application No. 2006-158795, filed Jun. 7, 2006, the entire contents of which are incorporated herein by reference.

### BACKGROUND OF THE INVENTION

1. Field of the Invention

This invention relates to the technology of charged particle beam drawing. More particularly, the present invention relates to a charged particle beam drawing apparatus, a charged particle beam drawing method, and a semiconductor device manufacturing method.

2. Description of the Related Art

In the process of manufacturing a semiconductor integrated circuit, the circuit pattern of each of the layers thereof is formed as it is aligned with the underlying master pattern arranged on a substrate to be processed (see, for example, JP-A 9-82603 [KOKAI]). Since the density of elements in semiconductor integrated circuits continues to increase, a high degree of alignment is required.

With conventional alignment techniques of electronic beam lithography systems, a misalignment measuring pattern is drawn on a resist film applied to a substrate to be processed and developed. Then, the amount of displacement is measured by a displacement checking apparatus. However, a displacement checking process using the displacement checking apparatus is time consuming so that the effective throughput falls and so does the productivity. Charged particle beam drawing apparatuses other than electron beam lithography systems such as those using an ion beam are accompanied by a similar problem.

### BRIEF SUMMARY OF THE INVENTION

According to an aspect of the present invention, there is provided a charged particle beam drawing apparatus comprising:

a drawing section which draws a pattern on a resist film applied to a substrate to be processed on which a under-layer mark is formed, by a charged particle beam;

a position computing section which computes a position of the under-layer mark and a position of a displacement measuring pattern drawn by the drawing section on the resist film using a correction coefficient, by scanning the under-layer mark and the displacement measuring pattern by a charged particle beam;

a displacement amount computing section which computes an amount of displacement from the positions of the under-layer mark and the displacement measuring pattern; and

a correcting section which corrects the correction coefficient according to the amount of displacement.

According to another aspect of the present invention, there is provided a charged particle beam drawing method comprising:

drawing a displacement measuring pattern on a resist film applied to a substrate to be processed on which a under-layer mark is formed, using a correction coefficient;

computing a position of the under-layer mark and a position of the displacement measuring pattern, by scanning the under-layer mark and the displacement measuring pattern by a charged particle beam;

computing an amount of displacement from the positions of the under-layer mark and the displacement measuring pattern;

correcting the correction coefficient according to the computed amount of displacement; and

drawing a pattern using the correction coefficient.

According to a further aspect of the present invention, there is provided a semiconductor device manufacturing method comprising:

drawing a displacement measuring pattern on a resist film applied to a substrate to be processed on which a under-layer mark is formed, using a correction coefficient;

computing a position of the under-layer mark and a position of the displacement measuring pattern, by scanning the under-layer mark and the displacement measuring pattern by a charged particle beam;

computing an amount of displacement from the positions of the under-layer mark and the displacement measuring pattern;

correcting the correction coefficient according to the computed amount of displacement; and

drawing a circuit pattern using the correction coefficient on the substrate to be processed.

### BRIEF DESCRIPTION OF THE SEVERAL VIEWS OF THE DRAWING

FIG. 1 is a schematic block diagram of an electron beam drawing apparatus according to an embodiment of the present invention;

FIG. 2 is a schematic illustration of the first shaping aperture mask and the CP aperture mask of the electron beam drawing apparatus according to the embodiment;

FIG. 3 is a schematic illustration of the CP system using the electron beam drawing apparatus according to the embodiment;

FIG. 4 is a schematic illustration of the VSB system using the electron beam drawing apparatus according to the embodiment;

FIG. 5 is a schematic plan view of a substrate to be processed according to the embodiment;

FIG. 6 is a schematic cross-sectional view of the substrate to be processed according to the embodiment;

FIG. 7 is a flowchart of the alignment mark detection method according to the embodiment;

FIG. 8 is a flowchart of the electron beam drawing method according to the embodiment;

FIG. 9 is a schematic plan view of a substrate to be processed when a displacement measuring pattern is drawn according to the embodiment;

FIG. 10 is a flowchart of the method of manufacturing a semiconductor device according to the embodiment;

FIG. 11 is a flowchart of an example of a first modified electron beam drawing method according to the embodiment;

FIG. 12 is a flowchart of an example of a second modified electron beam drawing method according to the embodiment;

FIG. 13 is a flowchart of an example of a third modified electron beam drawing method according to the embodiment;

FIG. 14 is a flowchart of another example of the third modified electron beam drawing method according to the embodiment;

FIG. 15 is a flowchart of a further example of the third modified electron beam drawing method according to the embodiment;

FIG. 16 is a flowchart of an example of a fourth modified electron beam drawing method according to the embodiment;

FIG. 17 is a graph illustrating the alignment mark and the image of the displacement measuring pattern of the fourth modified electron beam drawing method according to the embodiment;

FIG. 18 is a flowchart of another example of the fourth modified electron beam drawing method according to the embodiment;

FIG. 19 is a flowchart of a further example of the fourth modified electron beam drawing method according to the embodiment; and

FIG. 20 is a flowchart of an electron beam drawing method illustrated for the purpose of comparison.

### DETAILED DESCRIPTION OF THE INVENTION

An embodiment of the present invention and modifications thereof will be described in detail by referring to the accompanying drawings. Throughout the drawings, same or similar components are denoted by same or similar reference symbols.

While the embodiment of the present invention is described as being adapted to use an electron beam as a charged particle beam, it may alternatively be adapted to use an ion beam as a charged particle beam. In other words, the following description also applies to the use of an ion beam.

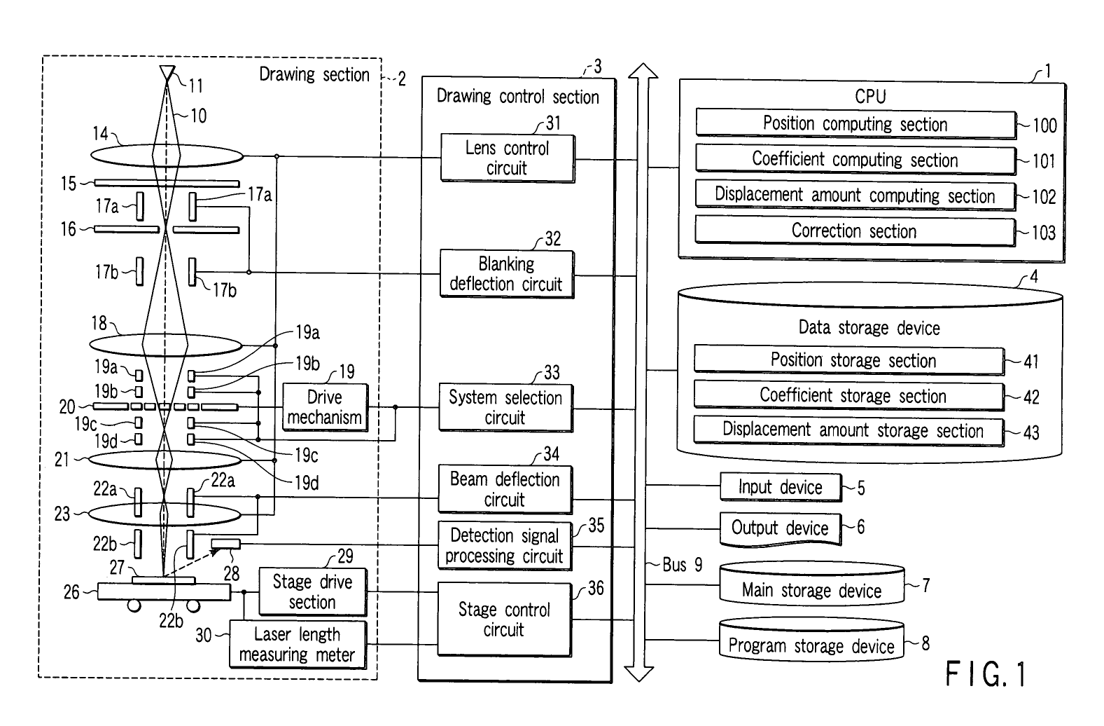

As shown in FIG. 1, the embodiment of electron beam drawing apparatus according to the present invention comprises a central processing unit (CPU) 1, a drawing section (electronic optical system) 2, a drawing control section 3, a data storage device 4, an input device 5, an output device 6, a main storage device 7 and a program storage device 8. Typically, the CPU 1, the drawing control section 3, the data storage device 4, the input device 5, the output device 6, the main storage device 7 and the program storage device 8 are connected to each other by way of a bus 9.

The drawing section 2 includes an electron beam generating source (electron gun) 11, a condenser lens 14, a first shaping aperture mask 15, a second shaping aperture mask (character projection (CP) aperture mask) 20, a blanking aperture mask 16, blanking deflectors 17a and 17b, a projection lens 18, character projection (CP) selection deflectors 19a, 19b, 19c and 19d, a compression lens 21, an objective lens 23, objective deflectors 22a and 22b and a drive mechanism 19. A specimen chamber (not shown) contains a stage 26 for mounting a substrate to be processed (wafer) 27 and a detector 28, which may be a Faraday cup, for detecting secondary electrons or reflected electrons from the substrate to be processed 27 as detection signal.

The electron gun 11 generates and ejects an electron beam 10. The condenser lens 14 adjusts the irradiation condition of the electron beam 10. The first shaping aperture mask 15 and the CP aperture mask 20 shape the electron beam 10 to a desired profile. The blanking aperture mask 16 turns on and off the electron beam 10 whenever necessary. The blanking deflectors 17a and 17b deflect the electron beam 10 onto the blanking aperture mask 16. The projection lens 18 forms an image on the CP aperture mask 20.

The CP selection deflectors 19a through 19d align the electron beam 10 to an appropriate position on the CP aperture mask 20 and select one of the CP apertures that the CP aperture mask 20 has. With this operation, the extent of optical overlaying of the first shaping aperture mask 15 and the CP aperture mask 20 is controlled to give shape to the electron beam 10.

The objective deflectors 22a and 22b deflect the electron beam 10 so as to make it scan the substrate to be processed 27. When the acceleration voltage is 5 keV, the sizes of the deflection regions of the objective deflectors 22a and 22b may, for example, be 1.5 mm and 50 μm respectively.

Electrostatic type deflectors are employed for the CP selection deflectors 19a through 19d and the objective deflectors 22a and 22b so as to deflect an electron beam 10 highly accurately at high speed. Each of the objective deflectors 22a and 22b includes a main deflector, a sub deflector and a plurality of diffraction electrodes for minimizing the aberration of diffraction in order to deflect highly accurately without reducing the throughput. The compression lens 21 and the objective lens 23 focus the electron beam 10 on the substrate to be processed 27.

The substrate to be processed 27 is typically a semiconductor wafer such as a silicon (Si) wafer to which resist is applied when a semiconductor device is manufactured by way of a direct drawing process, although it is a glass substrate to which resist is applied when an exposure mask is prepared. However, a glass substrate may be used as the substrate to be processed 27 when manufacturing a liquid crystal display by way of a direct drawing process. Similarly, a resin substrate such as a polycarbonate substrate may be used as substrate to be processed 27 when manufacturing an optical recording medium. It may be needless to say that one or more than one thin films are formed on the glass substrate or the resin substrate in the course of the manufacturing sequence.

The stage 26 can be moved in the X-direction and also in the Y-direction, or in intra-planar directions. The laser critical dimension measuring meter (interferometer) 30 observes the position of the stage 26. The stage drive section 29 drives the stage 26 to move according to the position of the stage 26 as observed by the laser critical dimension measuring meter 30.

For laser beam drawing, the electron beam 10 generated from the electron gun 11 is adjusted to show a desired current density by the condenser lens 14 and irradiated onto the first shaping aperture mask 15. The electron beam 10 that passes the rectangular aperture of the first shaping aperture mask 15 is focused on the CP aperture mask 20 by the projection lens 18. The image that is formed by the shaping effect of an optical overlaying of the first shaping aperture mask 15 and the CP aperture mask 20 is then compressed with a predetermined compression ratio by the compression lens 21 and focused on the substrate to be processed 27 by the objective lens 23. At this time, the electron beam 10 is deflected as the objective deflectors 22a and 22b form an electric field according to the deflection voltage applied by the beam deflection circuit 34. When moving the substrate to be processed 27, the electron beam 10 is deflected onto the blanking aperture mask 16 by the blanking deflectors 17a and 17b to consequently turn off the electron beam 10 so that the electron beam 10 may not strike the substrate to be processed 27 and no line may be drawn in the area of the substrate to be processed 27 that needs to be free from any drawn line.

The drawing control section 3 includes a lens control circuit 31, a blanking deflection circuit 32, a character projection (CP) selection circuit (system selection circuit) 33, a beam deflection circuit 34, a detection signal processing circuit 35 and a stage control circuit 36. The lens control circuit 31 applies a voltage to the condenser lens 14 for causing the latter to adjust the irradiation condition of the electron beam 10. The blanking deflection circuit 32 applies a deflection voltage to the blanking deflectors 17a and 17b to cause them to turn off the electron beam 10 whenever necessary. The CP selection circuit 33 applies a voltage to the CP selection deflectors 19athrough 19d to cause them control the extent of overlaying of the electron beam 10. The beam deflection circuit 34 applies a deflection voltage to the objective deflectors 22a and 22b to cause them deflect the electron beam 10. The detection signal processing circuit 35 converts the secondary electronics detected by the detector 28 into a signal and transmits the detection signal to the CPU 1. The stage control circuit 36 is connected to the stage drive section 29 and the laser critical dimension measuring meter 30. The stage control circuit 36 controls the position of the stage 26 by driving the stage drive section 29, referring to the coordinate position of the stage 26 as observed by the laser critical dimension measuring meter 30.

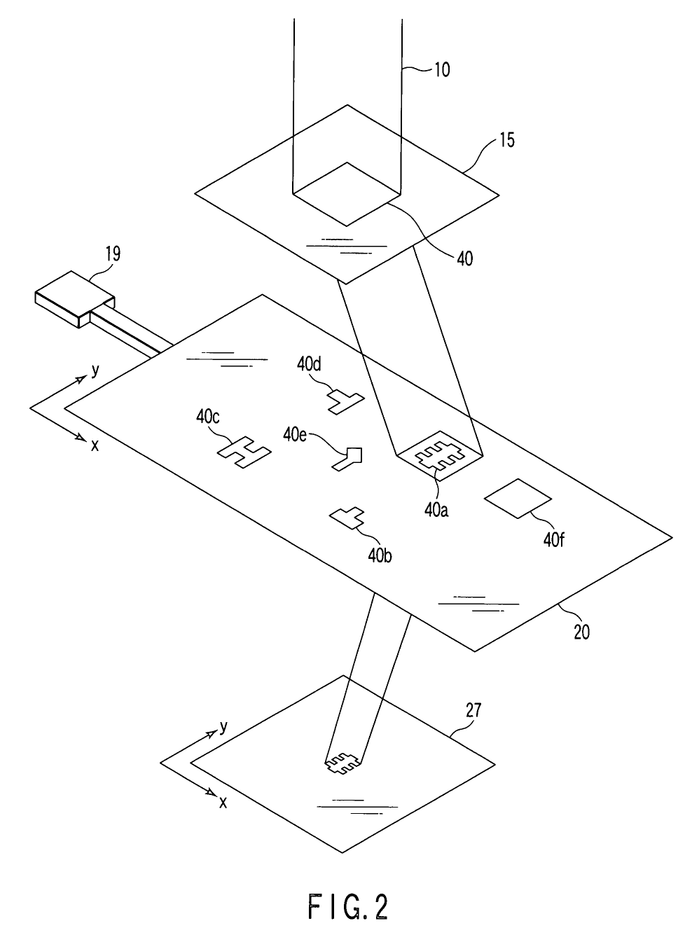

Now, the first shaping aperture mask 15 and the CP aperture mask 20 will be described below by way of examples illustrated in FIG. 2. The first shaping aperture mask 15 is provided with a rectangular aperture 40. The CP aperture mask 20 is provided with a plurality of apertures for CP (character apertures) 40a through 40e showing a high degree of repetitiveness that are to be used for a character projection (CP) system and an aperture for VSB 40f to be used for a variable shaping beam system (VSB). Character apertures can be formed in a single CP aperture mask 20 for a plurality of layers and selectively be used. The compression ratio of the character apertures 40a through 40e and the aperture for VSB 40f realized by the compression lens 21, the objective lens 23 and so on is typically 1/5. A compression ratio of 1/5 is assumed in the following description.

An LSI pattern is drawn on the substrate to be processed 27 by aligning the electron beam 10 by the CP selection deflectors 19a through 19d, giving the electron beam 10 the shape of the selected character aperture (e.g., the character aperture 40a) and irradiating the shaped electron beam (character beam) 10 to the desired position on the substrate to be processed 27 by the objective deflectors 22a and 22b. The character aperture 40e forms a rectangular or triangular electron beam (character beam) 10 as it is overlaid on the rectangular aperture 40 of the first shaping aperture mask 15, for instance.

The CP aperture mask 20 is provided with the drive mechanism 19. The drive mechanism 19 can drive the CP aperture mask 20 to move so as to selectively use the character apertures 40a through 40e and the aperture 40f for VSB for drawing. An ultrasonic stage drive mechanism, a piezoelectric element, an electric stage drive mechanism or a manual drive mechanism may be used for the drive mechanism 19.

Now, the method of controlling the electron beam 10 by the CP selection deflectors 19a through 19d will be described below. For a drawing operation, the CP selection circuit 33 shown in FIG. 1 determines the flag (VSB/CP flag) for selecting the VSB system or the CP system on the basis of the information transmitted from the CPU 1 that indicates the beam size, the aperture to be used, the beam position, the VSB/CP flag and so on and selectively switches the CP selection deflectors 19a through 19d according to the selected system.

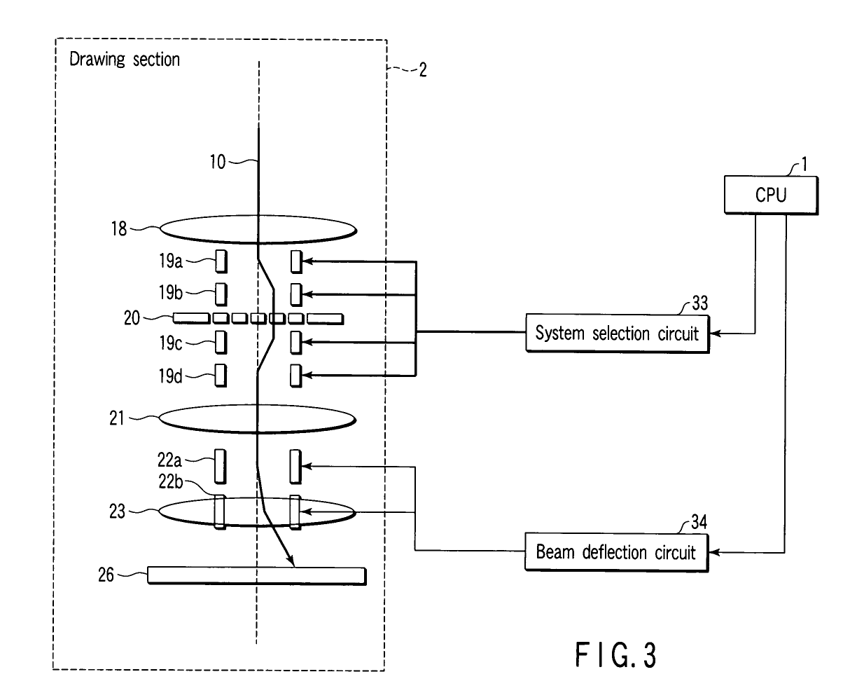

When the CP system is selected, the CP selection circuit 33 typically selects the four stage CP selection deflectors 19a through 19d as shown in FIG. 3. The CP selection deflector 19a deflects the electron beam 10 coming from the upstream side on the optical axis to the direction getting to the desired CP position. The deflected electron beam 10 is then swung back to the direction perpendicular to the CP aperture mask 20 by the CP selection deflector 19b. As a result, the electron beam 10 perpendicularly enters selected one of the character apertures 40a through 40e on the CP aperture mask 20. After passing through the selected one of the character apertures 40a through 40e of the CP aperture mask 20, the electron beam 10 is swung back to the direction getting to the optical axis by the CP selection deflector 19c and further swung back to move on the optical axis by the CP selection deflector 19d. Thus, as a result, the electron beam 10 is swung back to the same position on the optical axis regardless which one of the character aperture 40a through 40e it passes and enters the compression lens 21, the objective lens 23 and the objective deflectors 22a and 22b that are arranged downstream in the direction of the optical axis. Differently stated, the CP selection deflectors 19a through 19d can swing back the electron beam 10 to the same position on the optical axis regardless which one of the character apertures 40a through 40e on the CP aperture mask 20 the electron beam 10 passes. Therefore, if the electron beam 10 is deflected to a large extent on the CP aperture mask 20, it is possible to highly accurately draw lines on the substrate to be processed 27 without any substantial displacement. The voltage of each of the deflection amplifiers is ±40 V and then the deflection width is 1 mm on any of the character apertures 40a through 40e.

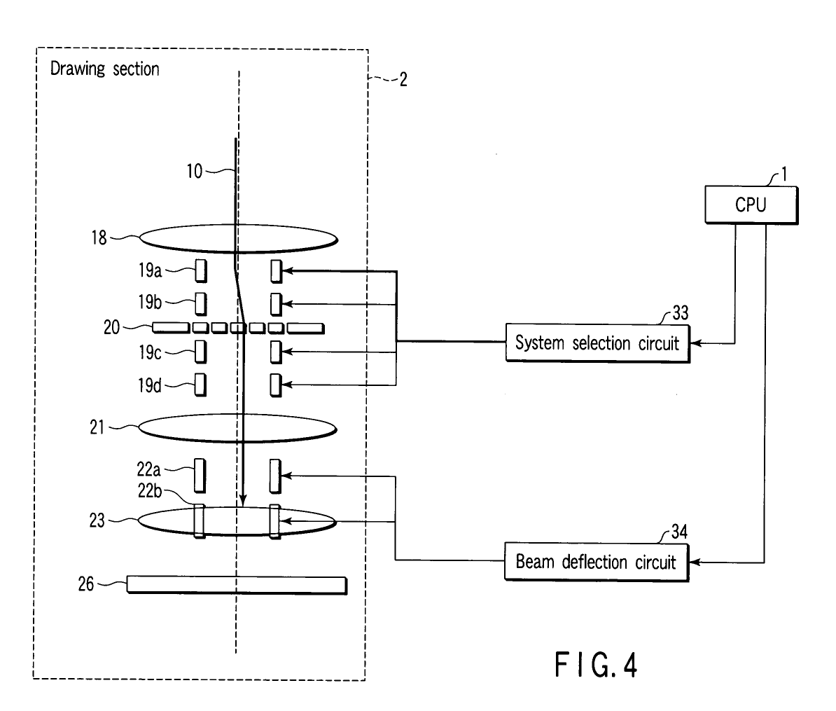

With the VSB system, on the other hand, for instance only the CP selection deflector 19a will be used as shown in FIG. 4. The deflection width can be made to be extremely small when the VSB system is used if compared with the deflection width that appears when the CP system is used provided that the aperture 40ffor the VSB system is arranged near the optical axis. 100 μm may be enough as the beam deflection width required for the VSB system on the aperture 40f for the VSB system. Then, since the deflection width on the aperture 40f for the VSB system is small, it is not necessary to swing back the electron beam 10 to the optical axis unlike the CP system. When the voltage for beam alignment is overlaid on the CP selection deflectors 19c and 19d, the voltage of the CP selection deflectors 19c and 19d is output. When the correction voltage for beam alignment is overlaid on the positioning deflector, it is not necessary to overlay it on the CP selection deflectors 19c and 19d. As described above, it is possible to selectively use the CP system or the VSB system and also one of the large number of character apertures 40a through 40e or the aperture 40f for the VSB system, whichever appropriate.

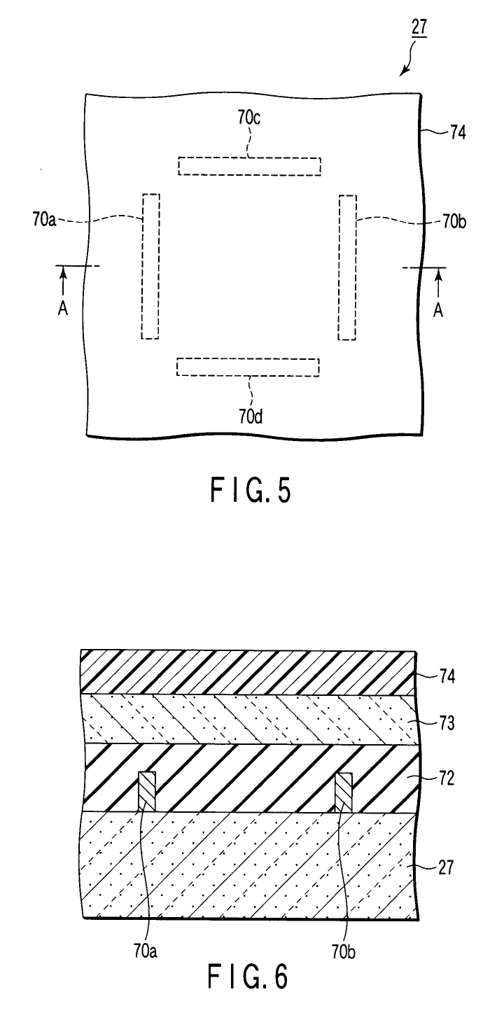

With this embodiment, under-layer marks (alignment marks) 70a through 70d are formed on the substrate to be processed 27 as shown in FIGS. 5 and 6. The alignment marks 70a through 70d are typically arranged on the dicing lines between chip regions. An interlayer insulation film 72, a film to be processed 73 and a resist film 74 are sequentially formed on the substrate to be processed 27 and the alignment marks 70a through 70d.

The CPU 1 illustrated in FIG. 1 includes a position computing section 100, a coefficient computing section 101, an amount of displacement computing section 102 and a correction section 103. The position computing section 100 computes the positions of the alignment marks 70a through 70d according to the detection signal detected by the detector 28 when the electron beam 10 is driven to scan the alignment marks 70a through 70d. The position computing section 100 also computates the position of the displacement measuring pattern according to the detection signal detected by the detector 28 when the electron beam 10 is driven to scan the displacement measuring pattern, which will be described hereinafter.

The coefficient computing section 101 computes the position of the chip region on the substrate to be processed 27 and the correction coefficient (strain coefficient) according to the positions of the alignment marks 70a through 70d determined by the position computing section 100. The strain coefficient can typically be expressed by a polynomial of second degree. Note that the strain coefficient of the substrate to be processed, the chip position and the strain coefficient of the chip may be computed in place of computing the chip position on the substrate to be processed 27 and the strain coefficient. When computing the correction coefficient, it is possible to reduce the mark detection errors by a statistic process. For example, the coefficient computing section 101 computes the correction coefficient by computing the strain on the substrate to be processed 27 on the basis of the chip position, subtracting the strain component of the substrate to be processed 27 from the positions of the alignment marks 70a through 70d and executing an averaging process on the strain of the chip from other position information on the alignment marks.

The amount of displacement computing section 102 adds the positions of the alignment marks 70a through 70d and the displacement measuring pattern as computed by the position computing section 100 and the position of the stage 26 at the time of mark detection as read from the laser critical dimension measuring system 30 and observes the amount of displacement. The amount of displacement on the substrate to be processed 27 may be expressed in terms of the stage coordinate system or in terms of the amount of displacement on the substrate to be processed 27 and the amount of displacement of the position of the chip.

The correction section 103 corrects the correction coefficient according to the amount of displacement as observed by the amount of displacement computing section 102. For instance, it corrects the correction coefficient by computing the amount of correction that is the offset for the amount of displacement and adding it to the correction coefficient. At this time, the correction coefficient stored in the coefficient storage section 42 of the data storage device 4 may be corrected or the amount of coefficient may be stored on a separate table and added to the correction coefficient in the drawing control section 3 at the time of the drawing operation.

Devices that can be used for the input device 5 include recognition devices such as a keyboard, a mouse and an OCR, graphic input devices such as an image scanner and input devices such as an audio input device. Devices that can be used for the output device 6 include displays such as liquid crystal displays and CRT displays and printers such as ink jet printers and laser printers.

The main storage device 7 operates as temporary data memory for temporarily storing the data to be used in the course of executing a program by the CPU 1 and for being used as working storage. Storage devices that can be used for the main storage device 7 include semiconductor memories, magnetic disks, optical disks, magneto-optical disks and magnetic tapes.

The data storage device 4 includes a position storage section 41 for storing the positions of the alignment marks 70a through 70d, the position of the displacement measuring pattern and so on, a coefficient storage section 42 for storing the correction coefficient computed by the coefficient computing section 101 and the correction coefficient corrected by correction section 103 and an amount of displacement storage section 43 for storing the amount of displacement observed by the amount of displacement computing section 102. Note that all the data necessary for a drawing operation are stored in the data storage device 4.

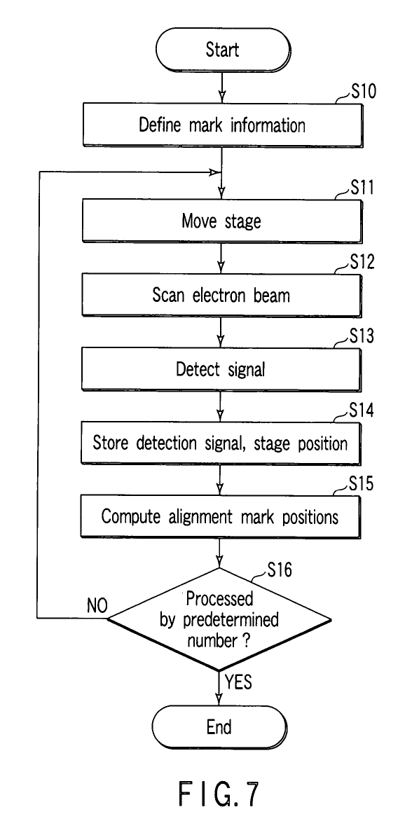

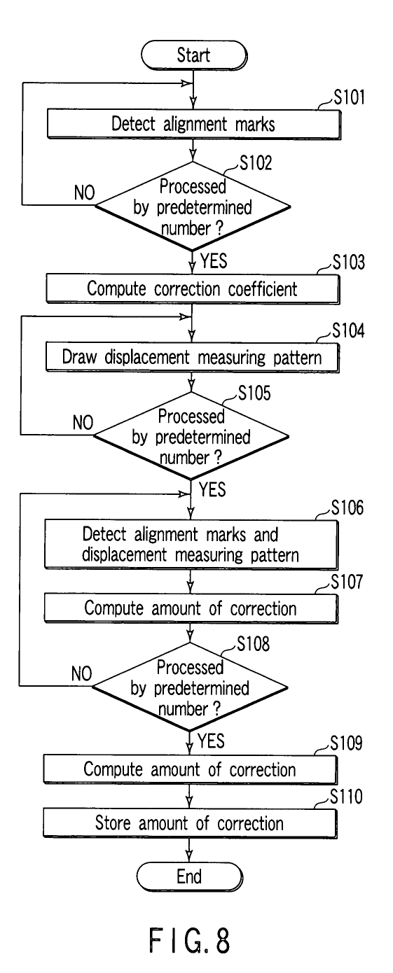

Before describing the electron beam drawing method by referring to the flowchart of FIG. 8, the alignment mark detection method that is employed in Step S101 of FIG. 8 will be described by referring to the flowchart of FIG. 7.

(a) In Step S10, mark information including the positions and the profiles of the alignment marks 70a through 70d shown in FIGS. 5 and 6 are defined. In Step S11, the stage 26 is driven to move so that the alignment marks 70a through 70d come into the range good for deflecting the beam right under the optical axis (deflection region).

(b) In Step S12, the electron beam 10 is driven to scan the alignment marks 70a through 70d. In Step S13, the detector 28 detects the detection signal on reflected electrons and secondary electrons produced as a result of the scanning operation of the electron beam 10. In Step S14, the detection signal and the position of the stage 26 at the time of detecting the mark as read from the laser critical dimension measuring system 30 are stored in the data storage device 4.

(c) In Step S15, the positions of the alignment marks 70a through 70d in the deflection region are detected according to the detection signal. Additionally, the positions of the alignment marks 70a through 70d and the position of the stage 26 are added to detect the positions of the alignment marks 70a through 70d on the substrate to be processed 27.

(d) In Step S16, when there are a plurality of alignment marks that correspond to a chip, it is determined if the positions of all the alignment marks that correspond to the chip are detected or not. The process ends when the positions of all the alignment marks that correspond to the chip are detected. If, on the other hand, the positions of all the alignment marks that correspond to the chip are not detected, the process returns to Step S11 to detect the remaining alignment mark or marks. Thus, the positions of all the alignment marks that correspond to the chip are detected and the processing operation of Step S101 shown in FIG. 8 ends.

Now, the charged particle beam drawing method of this embodiment that includes an alignment method will be described by referring to the flowchart of FIG. 8.

(a) In Step S101, the positions (coordinates) of the alignment marks 70a through 70d of each chip on the substrate to be processed 27 are detected as described above by way of Steps S10 through S16 in FIG. 7.

(b) In Step S102, it is determined if the positions of the alignment marks that correspond to all the chips are detected or not. If the positions of the alignment marks that correspond to all the chips are detected, the process proceeds to Step S103. If, on the other hand, the positions of the alignment marks that correspond to all the chips are not detected, the process returns to Step S101, where the positions of the alignment marks that correspond to the remaining chip or chips are detected. Thus, the positions of the alignment marks that correspond to all the chips are detected.

(c) In Step S103, the coefficient computing section 101 computes the chip positions on the substrate to be processed 27 and the strain coefficient according to the positions of the alignment marks 70a through 70d as correction coefficient.

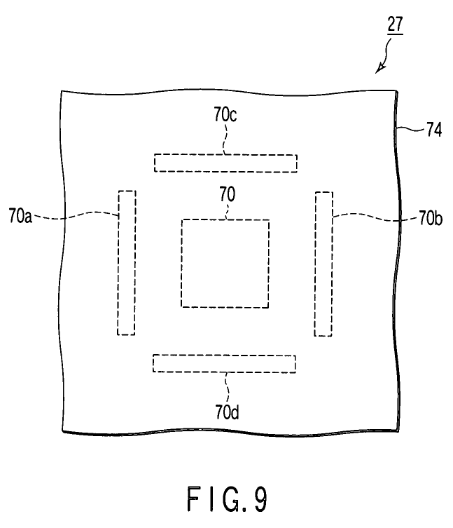

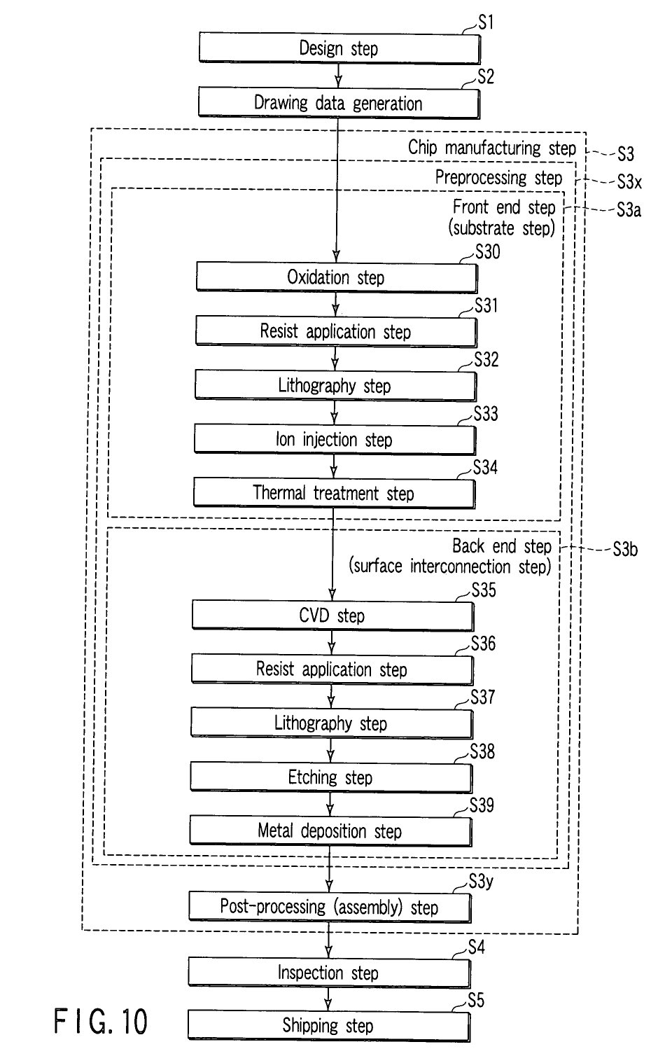

(d) In Step S104, the stage 26 is moved so that the alignment marks 70a through 70d come into the deflection region right under the optical axis according to the positions of the alignment marks 70a through 70d. The drawing section 2 draws the displacement measuring pattern 70 in the resist film 74 on the substrate to be processed 27 and near the alignment marks 70a through 70d using the correction coefficient computed by the coefficient computing section 101 as shown in FIG. 9. At this time, the displacement measuring pattern 70 is drawn with a rate of irradiation (e.g., 10 μC/cm² that is ten times greater than the ordinary rate of irradiation) greater than the ordinary rate of irradiation on device regions (e.g., 1 μC/cm²). To further increase the rate of irradiation, the displacement measuring pattern 70 may be drawn by the scanning feature of the electron beam 10. The displacement measuring pattern 70 can be drawn by narrowing the scanning range of the electron beam 10. For example, it is possible to draw a displacement measuring pattern 70 of 10 μm² by scanning an electron beam 10 of 10 μm² in the alignment marks 70a through 70d of 20 μm². At this time, an acceleration voltage in the low acceleration region (not higher than 5 keV) is employed. Then, it is possible to prevent the profile of the displacement measuring pattern 70 from being deformed by the scanning due to a proximity effect.

(e) In Step S105 in FIG. 8, it is determined if a displacement measuring pattern that corresponds to all the alignment marks is drawn or not. If it is determined that a displacement measuring pattern that corresponds to all the alignment marks is drawn, the process proceeds to Step S106. If, on the other hand, it is determined that a displacement measuring pattern that corresponds to all the alignment marks is not drawn, the process returns to Step S104 to draw a displacement measuring pattern that also corresponds to the remaining alignment marks.

(f) In Step S106, the stage 26 is moved so that the alignment marks 70a through 70d and the displacement measuring pattern 70 come right under the optical axis. Drawing conditions different from those for ordinary drawing operations are defined for drawing a displacement measuring pattern. For example, the negative voltage (retarding voltage) is defined to be −3 kV while the incident energy is defined to be 2 kV and the electron beam 10 is driven to scan a region that contains the alignment marks 70a through 70d and the displacement measuring pattern 70 on the resist film 74. Reflected electrons and secondary electrons that are produced as a result of the scanning operation are detected as detection signal. Then, the position computing section 100 computes the position of the displacement measuring pattern 70 and the positions of the alignment marks 70a through 70d according to the detection signal.

(g) In Step S107, the amount of displacement computing section 102 adds the positions of the alignment marks 70a through 70d and the position of the stage 26 at the time of detecting the marks to observe the amount of displacement. In Step S108, it is determined if the amounts of displacement that correspond to all the chips are observed or not. If it is determined that the amounts of displacement that correspond to all the chips are observed, the process proceeds to Step S109. If, on the other hand, it is determined that the amounts of displacement that correspond to all the chips are not observed, the process returns to Step S107 and the amount of displacement of the remaining chip or each of the remaining chips is observed.

(h) In Step S109, the correction section 103 computes the amount of correction for correcting the amount of displacement observed by the amount of displacement computing section 102. Additionally, the correction section 103 corrects the correction coefficient by using the amount of correction. In Step S110, the drawing section 2 executes a desired drawing process, using the correction coefficient corrected by the correction section 103. The entire process is completed when the drawing process ends.

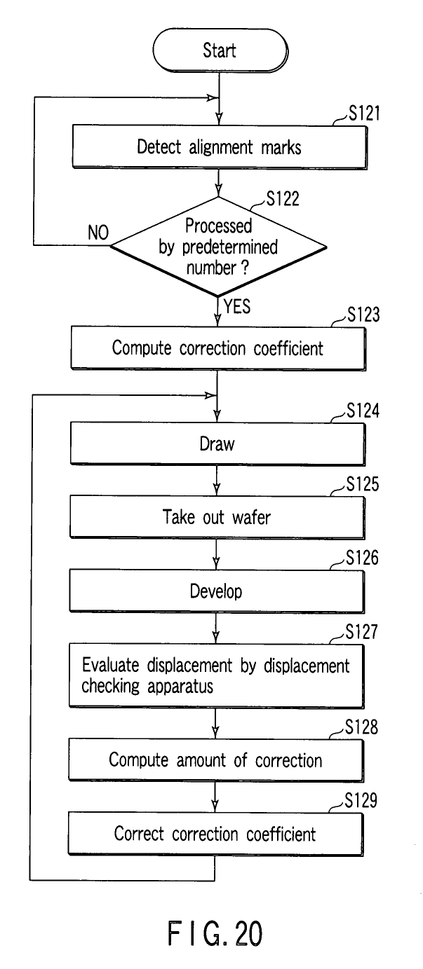

Now, a known alignment method will be described below for the purpose of comparison by referring to the flowchart of FIG. 20.

(a) Steps S121 through S123 are substantially the same as Steps S101 through S103 shown in FIG. 8 and hence will not be described repeatedly.

(b) In Step S124, a desired drawing process is executed by using a correction coefficient. At this time, a displacement measuring pattern is also drawn. After the end of the drawing process, the substrate to be processed is taken out from the electron beam drawing apparatus in Step S125. In Step S126, the drawn pattern is developed and the displacement measuring pattern is formed.

(c) In Step S127, the amount of displacement is observed by a displacement checking apparatus according to displacement measuring pattern to determine if the alignment is acceptable or to be rejected. In Step S128, the amount of correction is computed according to the amount of displacement. In Step S129, the correction coefficient is corrected according to the amount of correction. For the subsequent drawing operation, the corrected correction coefficient is fed back to the processing operation of Step S124 and a desired pattern is drawn by using the corrected correction coefficient.

With the alignment method illustrated in FIG. 20, the substrate to be processed is taken out to the outside and amount of displacement is checked by a displacement checking apparatus. Thus, the method of FIG. 20 is time consuming and involves high cost.

To the contrary, with the above-described embodiment, the amount of displacement can be detected by an in situ observation conducted in the inside of the electron beam drawing apparatus. Then, as a result, it is not necessary to use the displacement checking apparatus and rework the drawn pattern if any abnormality is detected by the displacement checking operation so that the pattern can be drawn at low cost. Additionally, the time for preparing a recipe in the displacement checking apparatus and the time for conveying the substrate to be processed are no longer required.

Furthermore, with the above-described embodiment, it is possible to examine the overlay, compute the amount of displacement and correct the displacement prior to the actual drawing operation. Thus, it is possible to avoid any operation of reworking the drawn pattern in the drawing process and consequently improve the actual drawing throughput. In other words, the displacement can be corrected before the actual drawing operation and it is possible to realize an overlay drawing operation highly accurately.

Still additionally, with the above-described embodiment, it is possible to clearly observe the latent image of displacement measuring pattern 70 by increasing the rate of irradiation of the electron beam 10 for drawing a displacement measuring pattern 70 relative to the rate of irradiation for drawing an ordinary device pattern to improve the overlay accuracy. Thus, the overlay accuracy can be improved.

The sequence of the process illustrated in FIG. 8 can be executed by controlling the electron beam drawing apparatus shown in FIG. 1 by a program using an algorithm equivalent to FIG. 8. Such a program may be stored in the program storage device 8 of the computer system of the electron beam drawing apparatus of this embodiment. The program can be stored in a computer-readable recording medium and the sequence of the process of this embodiment can be executed by causing the recording medium to be read into the program storage device 8 of the electron beam drawing apparatus.

The computer-readable recording medium as used herein refers to a medium that can store a program as selected from external memory devices of computers, semiconductor memories, magnetic disks, optical disks, magneto-optical disks and magnetic tapes. More specifically, the computer-readable recording medium includes flexible disks, CD-ROMs and MO disks. For example, the main body of the electron beam drawing apparatus can be configured so as to contain or to be externally connected to a flexible disk drive or an optical disk drive. The program stored in a flexible disk or in an optical disk can be installed in the program storage device 8 of the electron beam drawing apparatus by inserting the flexible disk or the optical disk into the flexible disk drive or the optical disk drive, whichever appropriate, by way of the insertion port thereof. It is also possible to use a ROM or a magnetic tape apparatus, for example, by connecting a predetermined drive. Similarly, it is possible to store the program in the program storage device 8 by way of a communication network such as the Internet.

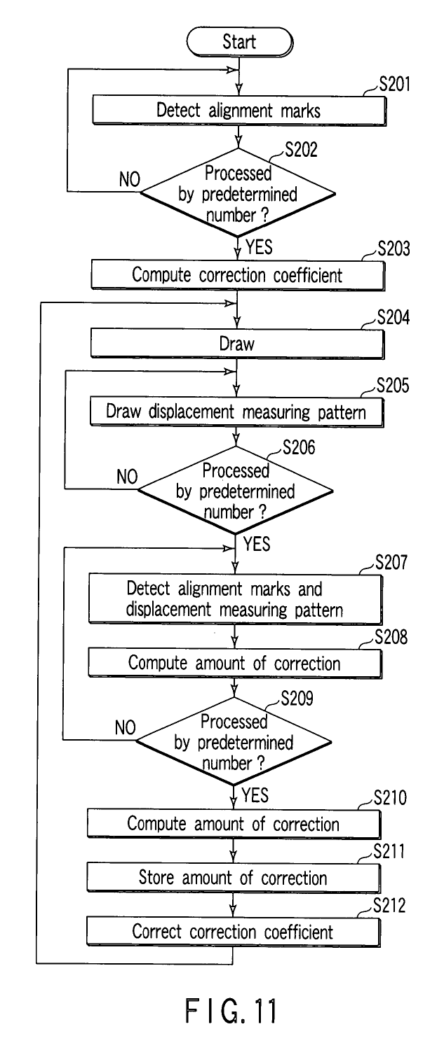

Now, the method of manufacturing a semiconductor device (LSI) by the electron beam drawing apparatus of FIG. 1 will be described by referring to the flowchart of FIG. 10. Note that the method of manufacturing a semiconductor device is described below only as an example. A semiconductor device can be manufactured by any other appropriate manufacturing method, which may be a method obtained by modifying this manufacturing method.

(a) In Step S1, an operation of a series of simulations including a process simulation, a lithography simulation, a device simulation and a circuit simulation is conducted to generate layout data (design data). In Step S2, the drawing data for drawing are directly generated according to the design data.

(b) In Step S3a, which is a front end step (substrate step), an oxidation Step S30, a resist application step S31, a direct drawing type lithography step S32, an ion implantation step S33, a heat treatment step S34 and other steps which may include a chemical vapor deposition (CVD) step and an etching step (not shown), are repeatedly conducted in a predetermined sequence. FIG. 10 illustrates part of the front end step as an example. FIG. 10 shows only an example, and thus, the heat treatment step S34 may be omitted and the process may directly proceed to the resist application step S31 or, alternatively, the ion implantation step may be arranged after the etching step. A photosensitive film (resist film) is typically coated on the substrate to be processed (wafer) in Step S31. In Step S32, an alignment operation is conducted in Step S32 by an electron beam drawing apparatus as shown in FIG. 1, following the sequence of Steps S101 through S110 shown in FIG. 8 to draw a pattern on the resist film on the substrate to be processed by a direct drawing process. Thereafter, the resist film is developed to produce an etching mask. In Step S33, ions are selectively implanted into the substrate to be processed by using the produced etching mask. As the front end step of Step S3a ends, the process proceeds to a CVD step S35 in the back end step S3b. It is not necessary to conduct all the lithography step of the front end step by way of a direct drawing process. For example, a direct drawing process may be employed only for the steps that involve critical dimensions such as a step of forming an etching mask for the gate electrode of a MOSFET.

(d) In Step S3b, the back end step (surface interconnection step) is conducted, in which a step of executing an interconnection process is carried out on the surface of the substrate. In the back end step, a CVD step S35 of forming an interlayer insulation film, a resist applying Step S36 of applying a resist to the interlayer insulation film, a lithography step S37 of carrying out a lithography by using direct drawing process, an etching step S38 of forming contact holes and via holes in the interlayer insulation film, and a metal deposition step S39, are repeatedly conducted. Although not shown, the metal film is subjected to a patterning process in another lithography step and a subsequent etching step that come after the metal deposition step S39. In the case of a Damascene step, after the etching step S38, a lithography step and the subsequent etching step are conducted to form a Damascene groove. Then, the metal deposition step S39 is conducted. Subsequently, the metal film is subjected to patterning in a CMP process. In the lithography step S37, an alignment operation is conducted by following the sequence of Steps S101 through S110 in FIG. 8, using the electron beam drawing apparatus of FIG. 1, in a manner similar to Step S32, and a pattern is drawn on the substrate to be processed by way of a direct drawing process. Thereafter, the resist is developed to form an etching mask made of resist. As the back end step S3b including the above-described step sequence ends, a multilayer interconnection structure is completed. In other words, the preprocessing step illustrated in Step S3x ends. As the preprocessing step ends, the process proceeds to Step S3y that is a post-processing step. As in the case of the front end step S3a, it is not necessary to conduct all of the lithography steps of the back end step S3b by way of a direct drawing process. For example, a direct drawing process may be employed only for specific steps such as a step of forming contact holes, although the present invention by no means restricts the use of a direct drawing process to all of the lithography steps.

(e) In Step S3y, a series of package assembly steps including a step of dividing the semiconductor wafer that is subjected to the above-described steps into chips, a step of mounting each chip on a packaging device, and a step of connecting the electrode pads and the leads of the lead frame on each chip, are conducted. After inspecting the semiconductor device manufactured by way of the above steps in Step S4, the semiconductor device is shipped in Step S5.

As described above, with a method of manufacturing a semiconductor device according to the embodiment, it is possible to measure the amount of displacement in situ in the inside of the electron beam drawing apparatus in the lithography steps S32 and S37. As a result, it is no longer necessary to rework the drawn pattern if any abnormality is detected by the measuring operation and the displacement checking operation of a displacement checking apparatus so that the pattern can be drawn at low cost. Additionally, the time for preparing a recipe in the displacement checking apparatus and the time for conveying the substrate to be processed that are conventionally required are no longer required. Furthermore, it is possible to examine the overlay, compute the amount of displacement and correct the displacement prior to the actual drawing operation. Thus, it is possible to avoid any operation of reworking the drawn pattern in the drawing process and consequently improve the actual drawing throughput. In other words, the displacement can be corrected before the actual drawing operation and it is possible to realize an overlay drawing operation highly accurately. Thus, it is possible to produce semiconductor devices at low cost and improve the effective throughput of manufacturing semiconductor devices.

An electron beam drawing apparatus as illustrated in FIG. 1 may be utilized for preparing a mask for exposure. If such is the case, drawing data are generated corresponding to each of the layers of the semiconductor chip by a CAD system and according to the surface pattern such as the layout designed in the design step S1. With use of the electron beam drawing apparatus (pattern generator) shown in FIG. 1, a mask for exposure is prepared for each of the layers on the mask substrate such as a quartz glass substrate by drawing a pattern, following the sequence of Steps S101 through S110 shown in FIG. 8 and a mask set is prepared. Then, a mask for ion implantation, an etching mask and other masks are prepared in the lithography steps such as Steps S32 and S37 by a drawing device such as a stepper. Thus, the device pattern of the mask for exposure for each corresponding layer is exposed on a photosensitive film on the substrate to be processed and subjected to a pattern operation. Then, the front end step including the part described above for Step S3a and the back end step including the part described above for Step S3b are conducted. It may be needless to say that an exposure process using a stepper and a direct drawing process may be combined.

### First Modified Method

Now, a first modified electron beam drawing method that is a modification to the above-described embodiment will be described by referring to the flowchart of FIG. 11.

(a) In Step S201, the positions (coordinates) of the alignment marks 70a through 70d of each chip on the substrate to be processed 27 are detected as described above for the sequence of Steps S10 through S16 shown in FIG. 7.

(b) In Step S202, it is determined if the positions of the alignment marks that correspond to all the chips are detected or not. If it is determined that the positions of the alignment marks that correspond to all of the chips are detected, the process proceeds to Step S203. If, on the other hand, it is determined that the positions of the alignment marks that correspond to all of the chips are not detected, the process returns to Step S201 to detect the positions of the alignment marks of the remaining chip or chips. In this way, the positions of the alignment marks that correspond to all of the chips are detected.

(c) In Step S203, the coefficient computing section 101 computes the positions of the chips on the substrate to be processed 27 and the correction coefficient (strain coefficient) according to the positions of the alignment marks 70a through 70d.

(d) In Step S204, the drawing section 2 draws a desired pattern, using the correction coefficient computed by the coefficient computing section 101.

(e) After the drawing process, a displacement measuring pattern 70 is drawn on a resist film 74 by a scanning operation of an electron beam 10 in Step S205 as in Step S104 described above by referring to FIG. 8.

(f) In Step S206, it is determined if a displacement measuring pattern that corresponds to all of the alignment marks is drawn or not. If it is determined that a displacement measuring pattern that corresponds to all of the alignment marks is drawn, the process proceeds to Step S207. If, on the other hand, it is determined that a displacement measuring pattern that corresponds to all of the alignment marks is not drawn, the process returns to Step S205 to draw a displacement measuring pattern that corresponds to all of the alignment marks.

(g) In Step S207, the alignment marks 70a through 70d and the displacement measuring pattern 70 are scanned by an electron beam 10 as in Step S107 described above by referring to FIG. 8. Reflected electrons and secondary electrons produced as a result of the scanning operation of the electron beam 10 are detected as a detection signal. Then, the position computing section 100 computes the position of the displacement measuring pattern 70 and the positions of the alignment marks 70a through 70d according to the detection signal.

(h) In Step S208, the displacement computing section 102 adds the positions of the alignment marks 70a through 70d and the position of the stage 26 at the time of detecting the marks and observes the amount of displacement. In Step S209, it is determined if the amount of displacement that corresponds to all of the chips is observed or not. If it is determined that the amount of displacement that corresponds to all of the chips is observed, the process proceeds to Step S210. If, on the other hand, it is determined that the amount of displacement that corresponds to all of the chips is not observed, the process returns to Step S207 to observe the amount of displacement that is not observed yet.

(i) In Step S210, the correction section 103 computes the amount of correction according to the amount of displacement. In Step S211, the correction section 103 stores the amount of correction in the data storage device 4. The amount of correction stored in the data storage device 4 is fed back in the next alignment step of drawing a pattern on the substrate to be processed to correct the correction coefficient.

Thus, with the first modified embodiment of the invention, it is possible to check the displacement after the drawing process in Step S204 and correct the drawing position on the next substrate to be processed. As a result, it is possible to improve the accuracy of alignment and hence the productivity of manufacturing semiconductor devices.

### Second Modified Method

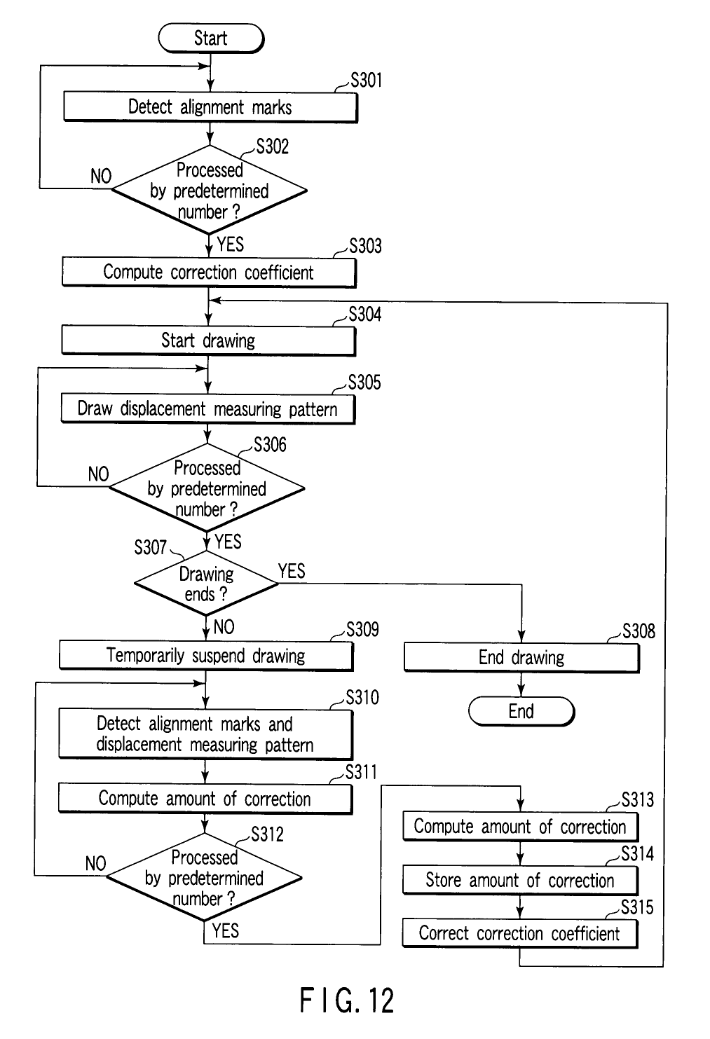

Now, a second modified electron beam drawing method that is a modification to the above-described embodiment will be described by referring to the flowchart of FIG. 12.

(a) In Step S301, the positions (coordinates) of the alignment marks 70a through 70d of each chip on the substrate to be processed 27 are detected as described above for the sequence of Steps S10 through S16 shown in FIG. 7.

(b) In Step S302, it is determined if the positions of the alignment marks that correspond to all of the chips are detected or not. If it is determined that the positions of the alignment marks that correspond to all of the chips are detected, the process proceeds to Step S303. If, on the other hand, it is determined that the positions of the alignment marks that correspond to all of the chips are not detected, the process returns to Step S301 to detect the positions of the alignment marks of the remaining chip or chips. In this way, the positions of the alignment marks that correspond to all of the chips are detected.

(c) In Step S303, the coefficient computing section 101 computes the positions of the chips on the substrate to be processed 27 and the correction coefficient (strain coefficient) according to the positions of the alignment marks 70a through 70d.

(d) In Step S304, the drawing section 2 starts a drawing process to draw a desired pattern, using the correction coefficient.

(e) During the drawing process, a displacement measuring pattern 70 is drawn on a resist film 74 near the alignment masks 70a through 70d by a scanning operation of an electron beam 10 in Step S305 as in Step S104 described above by referring to FIG. 8.

(f) In Step S306, it is determined if a displacement measuring pattern that corresponds to all of the alignment marks is drawn or not. If it is determined that a displacement measuring pattern that corresponds to all of the alignment marks is drawn, the process proceeds to Step S307. If, on the other hand, it is determined that a displacement measuring pattern 70 that corresponds to all of the alignment marks is not drawn, the process returns to Step S305 to draw a displacement measuring pattern that corresponds to all of the alignment marks.

(g) In Step S307, it is determined if the operation of drawing the desired pattern ends or not. If it is determined that the operation of drawing the desired pattern ends, the process ends in Step S308. On the other hand, if it is determined that the operation of drawing the desired pattern is still on the way, the process proceeds to Step S309, where it temporarily suspends the drawing operation.

(h) In Step S310, the alignment marks 70a through 70d and the displacement measuring pattern 70 are scanned by an electron beam 10 as in Step S107 described above by referring to FIG. 8. Reflected electrons and secondary electrons produced as a result of the scanning operation of the electron beam 10 are detected as a detection signal. Then, the position computing section 100 computes the position of the displacement measuring pattern 70 and the positions of the alignment marks 70a through 70d according to the detection signal.

(i) In Step S311, the displacement computing section 102 adds the positions of the alignment marks 70a through 70d and the position of the stage 26 at the time of detecting the marks and observes the amount of displacement.

(j) In Step S312, it is determined if the amount of displacement that corresponds to all of the chips is observed or not. If it is determined that the amount of displacement that corresponds to all of the chips is observed, the process proceeds to Step S313. If, on the other hand, it is determined that the amount of displacement that corresponds to all of the chips is not observed, the process returns to Step S310 to observe the amount of displacement that is not observed yet.

(k) In Step S313, the correction section 103 computes the amount of correction according to the amount of displacement. In Step S314, the correction section 103 stores the amount of correction in the data storage device 4. Additionally, the correction section 103 corrects the correction coefficient, using the amount of correction. The corrected correction coefficient is fed back to Step S304 for the subsequent operation of drawing a pattern on the substrate to be processed. Then, the operation of drawing a desired pattern is continued, using the corrected correction coefficient.

Thus, with the second modified embodiment of the invention, it is possible to check the displacement during the drawing process and correct the drawing position on the next substrate to be processed for the remaining part of the process. As a result, it is possible to improve the accuracy of alignment and hence the productivity of manufacturing semiconductor devices.

### Third Modified Method

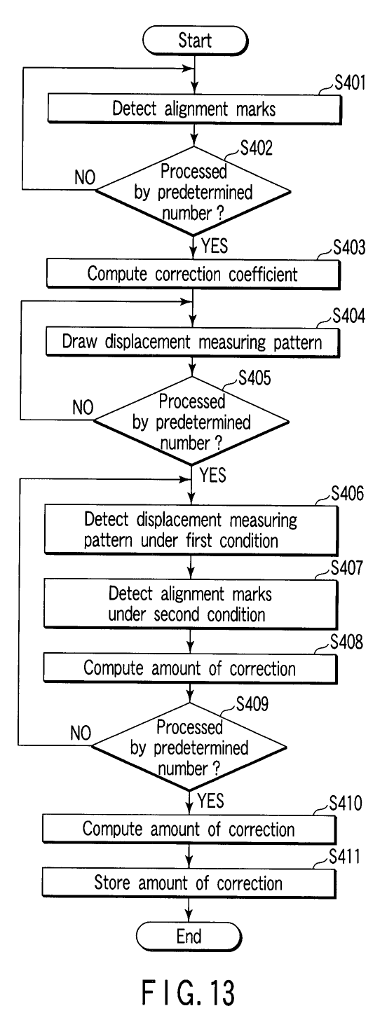

Now, a third modified electron beam drawing method that is a modification to the above-described embodiment will be described by referring to the flowchart of FIG. 13.

(a) The sequence of Steps S401 through S405 is similar to that of Steps S101 through S105 described above by referring to FIG. 8 and hence will not be described here any further.

(b) In Step S406, the displacement measuring pattern 70 is moved right under the optical axis. As the first drawing condition, the negative voltage is defined to be −4 kV while the incident energy is defined to be 1 kV and the electron beam 10 is driven to scan the displacement measuring pattern 70. Reflected electrons and secondary electrons that are produced as a result of the scanning operation are detected as detection signal. Then, the position computing section 100 computes the position of the displacement measuring pattern 70 on the basis of the detection signal.

(c) In Step S407, as the second drawing condition that differs from the first drawing condition, the negative voltage is defined to be −2 kV while the incident energy is defined to be 3 kV and the electron beam 10 is driven to scan the alignment marks 70a through 70d. Reflected electrons and secondary electrons that are produced as a result of the scanning operation are detected as detection signal. Then, the position computing section 100 computes the positions of the alignment marks 70a through 70d on the basis of the detection signal.

(d) In Step S408, the displacement computing section 102 measures the amount of displacement according to the positions of the alignment marks 70a through 70d and the position of the displacement measuring pattern 70. In Step S409, it is determined if the amount of displacement that corresponds to all of the chips is observed or not. If it is determined that the amount of displacement that corresponds to all of the chips is observed, the process proceeds to Step S410. If, on the other hand, it is determined that the amount of displacement that corresponds to all of the chips is not observed, the process returns to Step S406 to observe the amount of displacement that is not observed yet.

(e) The sequence of Steps S410 and S411 is similar to that of Steps S109 and S110 described above by referring to FIG. 8 and hence will not be described here any further.

Thus, with the third modified electron beam drawing method, it is possible to measure the amount of displacement in situ in the inside of the electron beam drawing apparatus. Then, as a result, it is no longer necessary to rework the drawn pattern if any abnormality is detected by the measuring operation and the displacement checking operation of a displacement checking apparatus so that the pattern can be drawn at low cost. Additionally, the time for preparing a recipe in the displacement checking apparatus and the time for conveying the substrate to be processed that are conventionally required are no longer required.

Furthermore, it is possible to examine the overlay, computate the amount of displacement and correct the displacement prior to the actual drawing operation. Thus, it is possible to avoid any operation of reworking the drawn pattern in the drawing process and consequently improve the actual drawing throughput. In other words, the displacement can be corrected before the actual drawing operation and it is possible to realize an overlay drawing operation highly accurately.

Still additionally, the alignment marks 70a through 70d and the displacement measuring pattern 70 are observed respectively in the first drawing condition and in the second drawing condition that are different from each other. Thus, it is possible to clearly discriminate the alignment marks 70a through 70d and the displacement measuring pattern 70 for observation so that it is possible to raise the accuracy of computing the amount of displacement. Then, as a result, it is possible to improve the throughput of manufacturing semiconductor devices.

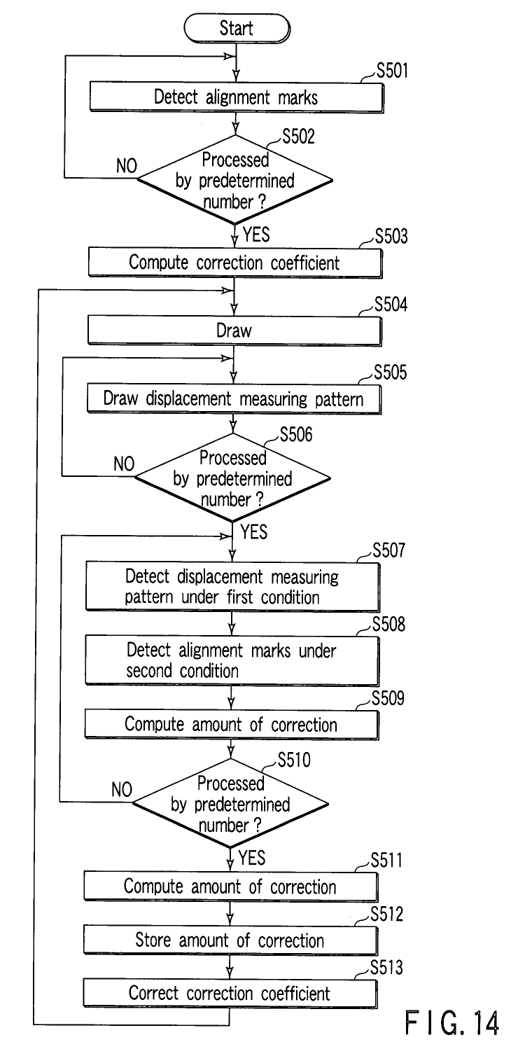

Note that the alignment marks 70a through 70d and the displacement measuring pattern 70 may be scanned respectively in conditions that are different from each other in Steps S507 and S508 after the drawing process of Step S504 as shown in FIG. 14. The sequence of Steps S501 through S506 and S509 through S513 is similar to that of Steps S201 through S206 and S208 through S213 described above by referring to FIG. 11 and hence will not be described here any further. With the electron beam drawing method illustrated in FIG. 14, it is possible to check the displacement, if any, after the drawing process and correct the drawing position for the next substrate to be processed. Then, it is possible to improve the accuracy of alignment and the productivity of manufacturing semiconductor devices.

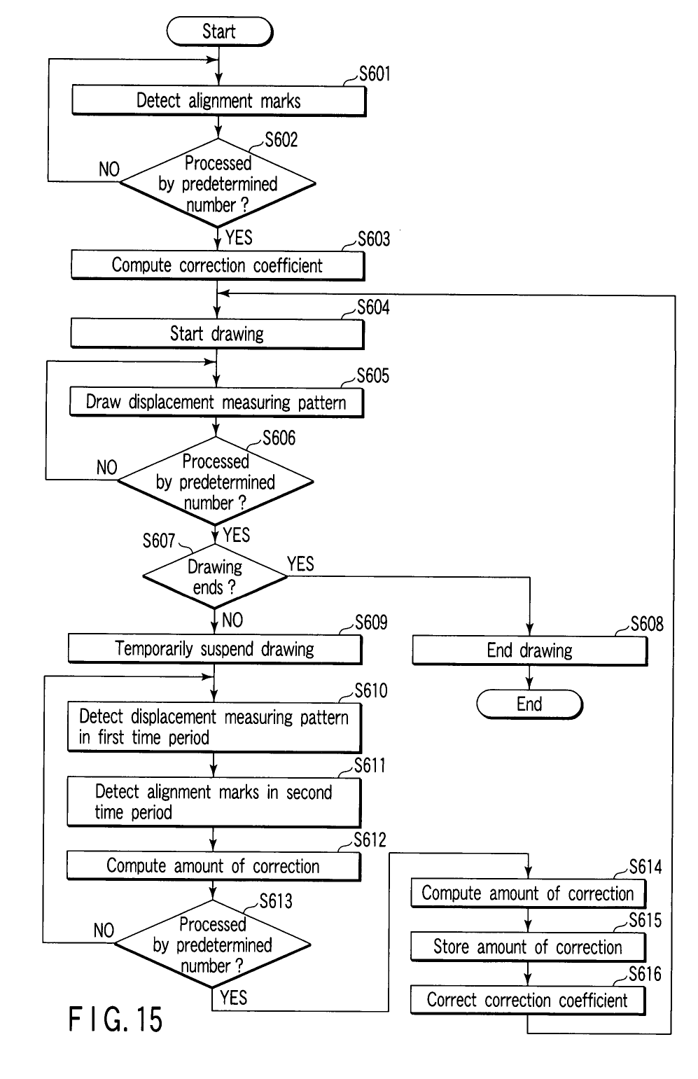

Furthermore, the alignment marks 70a through 70d and the displacement measuring pattern 70 may be scanned respectively in conditions that are different from each other in Steps S610 and S611 during the drawing process after the start of the drawing process in Step S604 as shown in FIG. 15. The sequence of Steps S601 through S609 and S612 through S616 is substantially similar to that of Steps S301 through S309 and S311 through S316 described above by referring to FIG. 12 and hence will not be described here any further. With the electron beam drawing method illustrated in FIG. 15, it is possible to check the displacement, if any, during the drawing process and correct the drawing position for the subsequent drawing operations. Then, it is possible to improve the accuracy of alignment and the productivity of manufacturing semiconductor devices.

### Fourth Modified Method

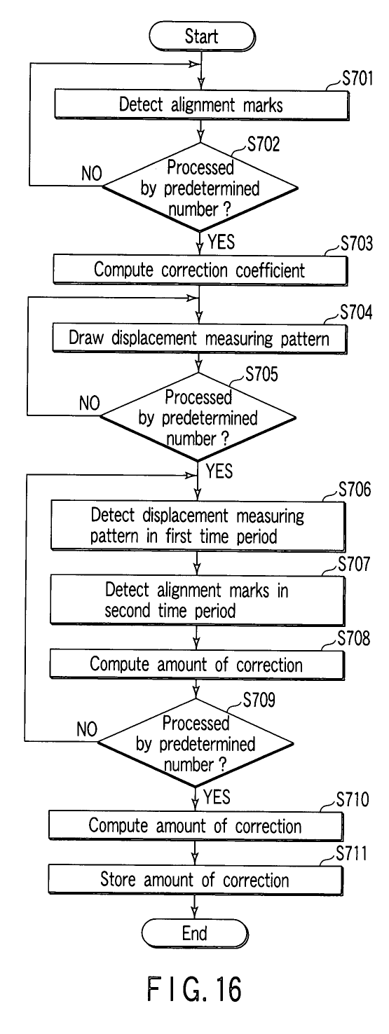

Now, a fourth modified electron beam drawing method that is a modification to the above-described embodiment will be described by referring to the flowchart of FIG. 16.

(a) The sequence of Steps S701 through S705 is similar to that of Steps S101 through S105 described above by referring to FIG. 8 and hence will not be described here any further.

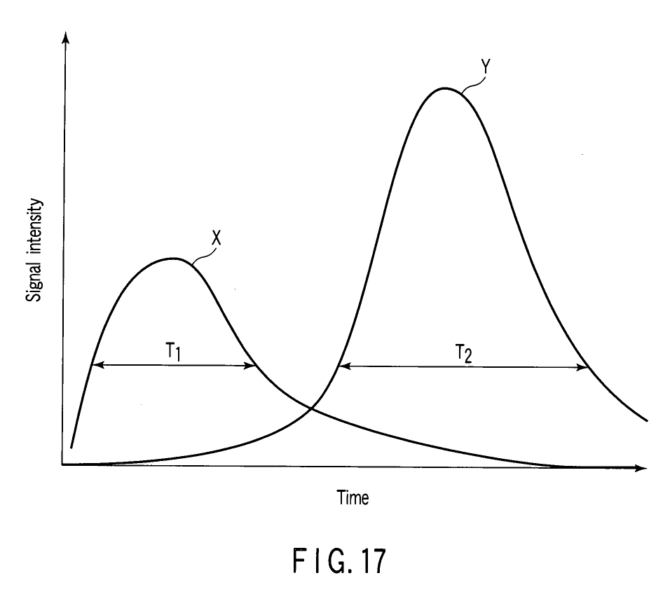

(b) In Step S706, the alignment marks 70a through 70d and the displacement measuring pattern 70 are moved right under the optical axis. The negative voltage is defined to be −3.8 kV while the incident energy is defined to be 1.2 kV and the electron beam 10 is driven to scan the displacement measuring pattern 70. Reflected electrons and secondary electrons that are produced as a result of the scanning operation are detected as detection signal. At this time, an image is acquired for each scan. When the electron beam 10 is driven to scan in the direction from the alignment mark 70a to the displacement measuring pattern 70 and the alignment mark 70b, a latent image X of the displacement measuring pattern 70 appears first and, after a while, an image Y of the alignment marks 70a through 70d appears as shown in FIG. 17. Therefore, in Step S706, the video data of the first time span T1 when the displacement measuring pattern 70 appears is processed to acquire a latent image of the displacement measuring pattern 70 and detect the position of the displacement measuring pattern 70. Then, in Step S707, the video data of the second time span T2 when the alignment marks 70a through 70d appear is processed to acquire a secondary electronic image or a reflected electronic image of the alignment marks 70a through 70d and detect the positions of the alignment marks 70a through 70d.

(c) The sequence of Steps S708 through S711 is similar to that of Steps S107 through S110 described above by referring to FIG. 8 and hence will not be described here any further.

Thus, with the fourth modified electron beam drawing method, it is possible to measure the amount of displacement in situ in the inside of the electron beam drawing apparatus. Then, as a result, it is no longer necessary to rework the drawn pattern if any abnormality is detected by the measuring operation and the displacement checking operation of a displacement checking apparatus so that the pattern can be drawn at low cost. Additionally, the time for preparing a recipe in the displacement checking apparatus and the time for conveying the substrate to be processed 27 that are conventionally required are no longer required.

Furthermore, it is possible to examine the overlay, computate the amount of displacement and correct the displacement prior to the actual drawing operation. Thus, it is possible to avoid any operation of reworking the drawn pattern in the drawing process and consequently improve the actual drawing throughput. In other words, the displacement can be corrected before the actual drawing operation and it is possible to realize an overlay drawing operation highly accurately.

Additionally, the alignment marks 70a through 70d and the displacement measuring pattern 70 are observed respectively in different time spans (timings) T1 and T2 with the fourth modified electron beam drawing method. When they are observed in the same drawing condition, the timing T1 when the displacement measuring pattern 70 appears and the timing T2 when the alignment marks 70a through 70d appear differ from each other. Thus, it is possible to clearly observe the displacement measuring pattern 70 and the individual alignment marks 70a through 70d by acquiring their images respectively at optimum timings T1 and T2. Then, it is possible to improve the accuracy of computing the amount of displacement and hence the throughput of manufacturing semiconductor devices.

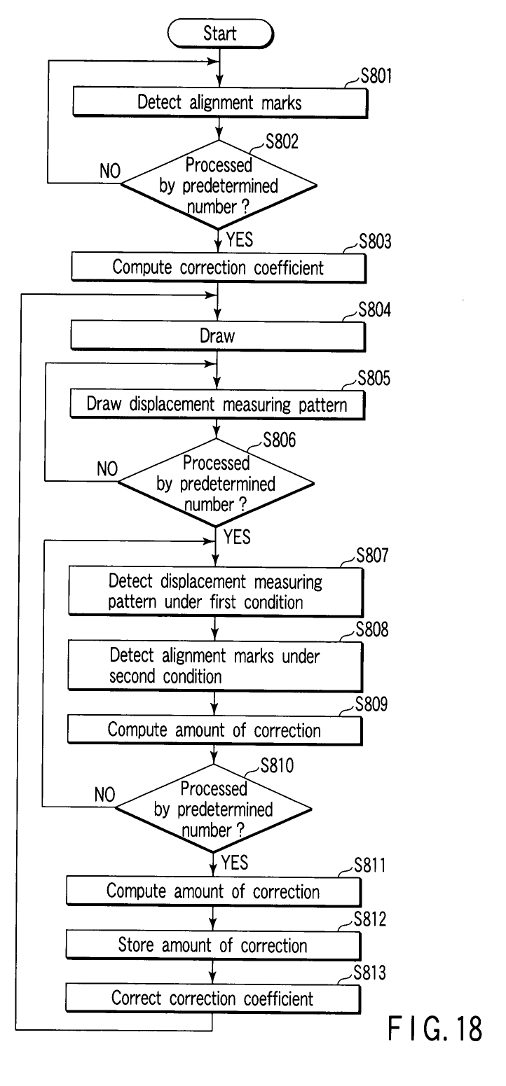

Note that the latent image of the displacement measuring pattern 70 and the secondary electron image of the alignment marks 70a through 70d may be detected respectively in time spans that are different from each other in Steps S807 and S808 after drawing a desired pattern in Step S804 as shown in FIG. 18. The sequence of Steps S801 through S806 and S809 through S813 is substantially similar to that of Steps S201 through S206 and S208 through S213 described above by referring to FIG. 11 and hence will not be described here any further. With the electron beam drawing method illustrated in FIG. 18, it is possible to correct the drawing position for the next substrate to be processed. Then, it is possible to improve the accuracy of computing the amount of displacement and hence the throughput of manufacturing semiconductor devices.

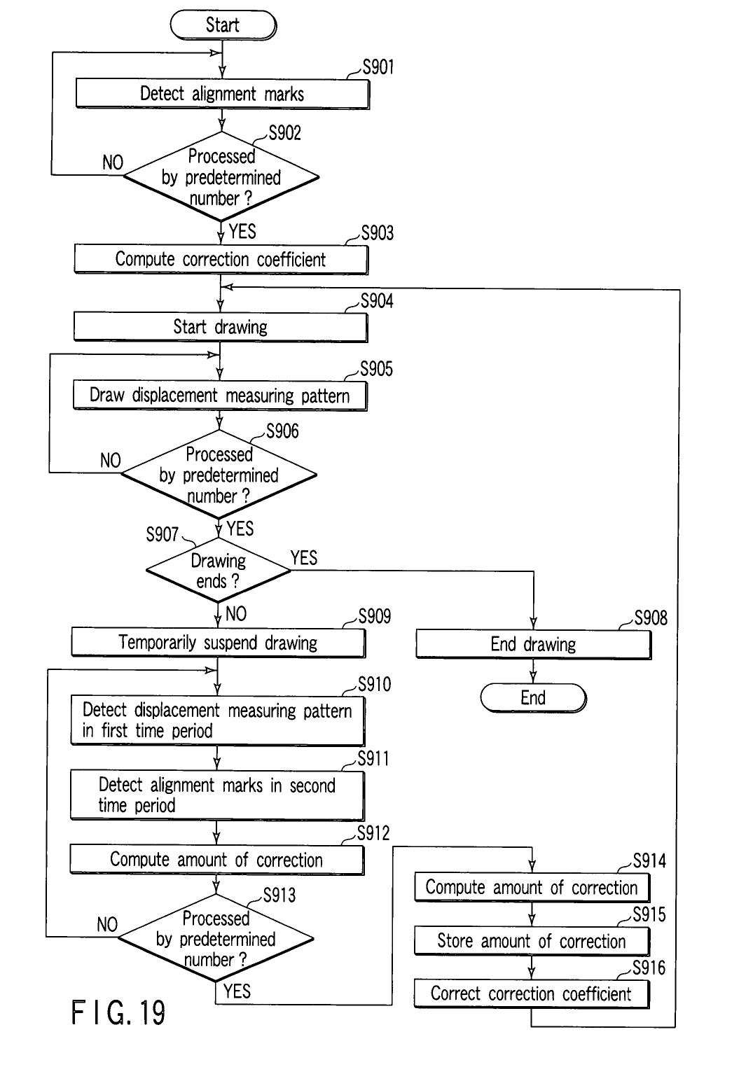

Also, note that the latent image of the displacement measuring pattern 70 and the secondary electron image of the alignment marks 70a through 70d may be detected respectively in time spans that are different from each other in Steps S910 and S911 after the start of the drawing process in Step S904 as shown in FIG. 19. The sequence of Steps S901 through S909 and S912 through S916 is substantially similar to that of Steps S301 through S309 and S311 through S316 described above by referring to FIG. 12 and hence will not be described here any further. With the electron beam drawing method illustrated in FIG. 19, it is possible to check the displacement, if any, during the drawing process and correct the drawing position for the subsequent drawing operations. Then, it is possible to improve the accuracy of alignment and hence the throughput of manufacturing semiconductor devices.

While the present invention is described above by way of the embodiment and modifications, it should be understood that the embodiment and modifications do not limit the scope of the present invention.

For example, while alignment marks are described above as under-layer marks 70a through 70d, it may alternatively be so arranged that alignment marks are not reutilized for measuring a displacement and displacement measuring marks that are different from alignment marks may be formed on the substrate to be processed 27. The positions of arrangement and the profiles of the under-layer marks 70a through 70d and the displacement measuring pattern 70 are by no means subjected to limitations.

While a method of manufacturing a semiconductor device is described above by way of the embodiment, it will be clear from the above description that the present invention is applicable to manufacturing various electronic devices including liquid crystal devices, magnetic recording media, optical recording media, thin film magnetic heads and superconducting elements. Also, it will be clear from the above description that the present invention is applicable to processes for manufacturing various industrial products such as processes for manufacturing automobiles, processes for manufacturing chemicals and processes for manufacturing building components.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A charged particle beam drawing apparatus comprising:
a drawing section which draws a pattern on a resist film applied to a substrate to be processed on which a under-layer mark is formed, by a charged particle beam;
a position computing section which computes a position of the under-layer mark and a position of a displacement measuring pattern drawn by the drawing section on the resist film using a correction coefficient, by scanning the under-layer mark and the displacement measuring pattern by a charged particle beam;
a displacement amount computing section which computes an amount of displacement from the positions of the under-layer mark and the displacement measuring pattern; and
a correcting section which corrects the correction coefficient according to the amount of displacement.

2. A charged particle beam drawing apparatus according to claim 1, further comprising:
a drawing control section which controls the drawing section;
a position storage section which stores information of the positions of the under-layer mark and the displacement measuring pattern computed by displacement amount computing section; and
a coefficient storage section which stores the correction coefficient corrected by the correction section.

3. A charged particle beam drawing apparatus according to claim 1, wherein the under-layer mark is a position aligning mark.

4. A charged particle beam drawing method comprising:
drawing a displacement measuring pattern on a resist film applied to a substrate to be processed on which a under-layer mark is formed, using a correction coefficient;
computing a position of the under-layer mark and a position of the displacement measuring pattern, by scanning the under-layer mark and the displacement measuring pattern by a charged particle beam;
computing an amount of displacement from the positions of the under-layer mark and the displacement measuring pattern;
correcting the correction coefficient according to the computed amount of displacement; and
drawing a pattern using the correction coefficient.

5. The charged particle beam drawing method according to claim 4, wherein the drawing of the pattern using the correction coefficient is conducted before the drawing of the displacement measuring pattern, simultaneously with the drawing of the displacement measuring pattern, or after the correcting of the correction coefficient.

6. The charged particle beam drawing method according to claim 4, wherein in the drawing of the displacement measuring pattern, a stage on which the substrate to be processed is placed is moved based on the position of the under-layer mark so that the under-layer mark comes into a deflection region right under the optical axis.

7. The charged particle beam drawing method according to claim 4, wherein an irradiation rate of the charged particle beam in the drawing of the displacement measuring pattern is larger than an irradiation rate in the drawing of the patterns.

8. The charged particle beam drawing method according to claim 4, wherein an acceleration rate of the charged particle beam in the drawing of the displacement measuring pattern is smaller than an acceleration rate in the drawing of the patterns.

9. The charged particle beam drawing method according to claim 4, wherein in the scanning of the under-layer mark and the displacement measuring pattern, the under-layer mark and the displacement measuring pattern are scanned under different drawing conditions from each other.

10. The charged particle beam drawing method according to claim 4, wherein in the scanning of the under-layer mark and the displacement measuring pattern, the under-layer mark is scanned under a first drawing condition and the displacement measuring pattern is scanned under a second drawing condition.

11. A semiconductor device manufacturing method comprising:
drawing a displacement measuring pattern on a resist film applied to a substrate to be processed on which a under-layer mark is formed, using a correction coefficient;
computing a position of the under-layer mark and a position of the displacement measuring pattern, by scanning the under-layer mark and the displacement measuring pattern by a charged particle beam;
computing an amount of displacement from the positions of the under-layer mark and the displacement measuring pattern;
correcting the correction coefficient according to the computed amount of displacement; and
drawing a circuit pattern using the correction coefficient on the substrate to be processed.

12. The semiconductor device manufacturing method according to claim 11, wherein in the drawing of the displacement measuring pattern, a stage on which the substrate to be processed is placed is moved based on the position of the under-layer mark so that the under-layer mark comes into a deflection region right under the optical axis.

13. The semiconductor device manufacturing method according to claim 11, wherein an irradiation rate of the charged particle beam in the drawing of the displacement measuring pattern is larger than an irradiation rate in the drawing of the patterns.

14. The semiconductor device manufacturing method according to claim 11, wherein an acceleration rate of the charged particle beam in the drawing of the displacement measuring pattern is smaller than an acceleration rate in the drawing of the patterns.

15. The semiconductor device manufacturing method according to claim 11, wherein in the scanning of the under-layer mark and the displacement measuring pattern, the under-layer mark and the displacement measuring pattern are scanned under different drawing conditions from each other.

16. The semiconductor device manufacturing method according to claim 11, wherein in the scanning of the under-layer mark and the displacement measuring pattern, the under-layer mark is scanned under a first drawing condition and the displacement measuring pattern is scanned under a second drawing condition.
